(19) United States
(12) Patent Application Publication
(10) Pub. No.: US 2023/0183009 A1
(43) Pub. Date: Jun. 15, 2023

(54) Moving Bag Apparatus and Methods of Using the Same

(71) Applicant: David Battershell, Antioch, IL (US)

(72) Inventor: David Battershell, Antioch, IL (US)

(21) Appl. No.: 18/078,598

(22) Filed: Dec. 9, 2022

Related U.S. Application Data
(60) Provisional application No. 63/287,597, filed on Dec. 9, 2021.

(51) Int. Cl. B65G 7/02

(52) U.S. Cl. CPC B65G 7/02

(57) ABSTRACT

The present invention relates to a bag apparatus and/or multilayer absorbent tarp for moving heavy items, specifically heavy items that may leak oils and other like material. Methods of using the same are further provided.

### CROSS-REFERENCE TO RELATED APPLICATIONS

The present invention claims priority to U.S. Prov. Pat. App. No. 63/287,597, titled “Moving Bag Apparatus and Methods of Using the Same,” filed Dec. 9, 2021, which is incorporated herein by reference in its entirety.

### TECHNICAL FIELD

The present invention relates to a bag apparatus and/or multilayer absorbent tarp for moving heavy items, specifically heavy items that may leak oils and other like material. Methods of using the same are further provided.

### BACKGROUND

It is typically difficult to move heavy items, especially items into or out of buildings, such as homes. Oftentimes, because doors and/or staircases may be relatively narrow, it may be difficult to utilize moving equipment that may make it easier. Moreover, homes may typically have nice floors and dropping or dragging heavy items thereacross may cause damage.

In addition, many appliances within a home may have debris, fluids, or other materials therein that can spill. For example, a water heater may have residual water therein, oftentimes mixed with rust, mineral deposits or other like contaminants. It is often the case that a water heater is utilized on the bottom floor of a home, such as in a basement, whereby when removing the same, it must be carried up relatively narrow staircases and through relatively narrow doors. The potential for spilling debris, fluids, and other like material from within the water heater is high. Other appliances may have damaging fluids, such as fuels, oils, or other like fluids that may be difficult to clean if spilled.

A need, therefore, exists for an improved moving bag. Specifically, a need exists for an improved moving bag that may be secured around an item to be moved. More specifically, a need exists for an improved moving bag that may encapsulate an item and allow the item to be moved through a space without causing damage thereto.

Moreover, a need exists for an improved moving bag that may catch spills of debris, fluids, or other like materials therefrom. Specifically, a need exists for an improved moving bag that may prevent spills of debris, fluids, or other like materials from causing damage. More specifically, a need exists for an improved moving bag that may absorb fluids, thereby also preventing damage.

### SUMMARY OF THE INVENTION

The present invention relates to a bag apparatus and/or multilayer absorbent tarp for moving heavy items, specifically heavy items that may leak oils and other like material. Methods of using the same are further provided.

To this end, in an embodiment of the present invention, a moving bag apparatus is provided. The moving bag apparatus comprises a top layer of absorbent material and a bottom layer of absorbent material, wherein the top layer and the bottom layer are attached together around a periphery thereof, wherein the top layer may comprise a zipper for accessing an interior space between the top layer and the bottom layer, and further wherein the top layer may have at least one strap or other protuberance extending therefrom.

In an embodiment, the moving bag apparatus further comprises an opening between the top layer and the bottom layer at a peripheral location thereof.

In an embodiment, the moving bag apparatus further comprises a fluid blocking layer in the bottom layer.

In an embodiment, the fluid blocking layer is disposed beneath the absorbent fabric material so that the absorbent fabric material of the bottom layer is positioned adjacent to the interior space.

In an embodiment, the moving bag apparatus further comprises a fluid blocking layer in the top layer.

In an embodiment, the fluid blocking layer is disposed above the absorbent fabric material so that the absorbent fabric material of the top layer is positioned adjacent to the interior space.

In an embodiment, the bottom layer has a coefficient of friction configured to allow a user to manually drag the moving bag apparatus across a floor.

In an embodiment, the zipper runs longitudinally across the top layer.

In an embodiment, the moving bag apparatus comprises a plurality of webbing straps attached to the top layer.

In an embodiment, the moving bag apparatus comprises at least one tie-down anchor point on the top layer.

In an alternate embodiment of the present invention, a method of using a moving bag apparatus is provided. The method comprises the steps of: providing a moving bag apparatus comprising a top layer of absorbent fabric material and a bottom layer of absorbent fabric material, wherein the top layer and the bottom layer are attached together around a periphery of each of the top layer and the bottom layer, wherein the top layer comprises a zipper for accessing an interior space between the top layer and the bottom layer, and wherein the top layer comprises at least one webbing strap extending therefrom; opening the zipper in the top layer; and placing an item within the interior space.

In an embodiment, the method further comprises the step of: closing the zipper around the item within the interior space.

In an embodiment, the method further comprises the step of: attaching the webbing strap around the item within the interior space.

In an embodiment, the method further comprises the steps of: providing an opening between the top layer and the bottom layer at a peripheral location thereof; and accessing the item within the interior space via the opening between the top layer and the bottom layer.

In an embodiment, the method further comprises the step of: providing a fluid blocking layer in the bottom layer, the top layer, or both the bottom layer and the top layer.

In an embodiment, the fluid blocking layer is disposed adjacent the absorbent fabric material in the top layer or the bottom layer or both the top layer and the bottom layer so that the absorbent fabric material of the bottom layer, the top layer, or both the bottom layer and the top layer is positioned adjacent to the interior space.

In an embodiment, the bottom layer has a coefficient of friction configured to allow a user to manually drag the moving bag apparatus across a floor, and comprising the step of: dragging the moving bag apparatus having the item therein across a floor.

In an embodiment, the zipper runs longitudinally across the top layer.

In an embodiment, the method further comprises the step of: providing a plurality of webbing straps attached to the top layer.

In an embodiment, the method further comprising the step of: providing at least one tie-down anchor point on the top layer.

It is, therefore, an advantage and objective of the present invention to provide an improved moving bag.

Specifically, it is an advantage and objective of the present invention to provide an improved moving bag that may be secured around an item to be moved.

More specifically, it is an advantage and objective of the present invention to provide an improved moving bag that may encapsulate an item and allow the item to be moved through a space without causing damage thereto.

Moreover, it is an advantage and objective of the present invention to provide an improved moving bag that may catch spills of debris, fluids, or other like materials therefrom.

Specifically, it is an advantage and objective of the present invention to provide an improved moving bag that may prevent spills of debris, fluids, or other like materials from causing damage.

More specifically, it is an advantage and objective of the present invention to provide an improved moving bag that may absorb fluids, thereby also preventing damage.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a perspective view of a moving bag in an embodiment of the present invention.

FIG. 2 illustrates a perspective view of a moving bag showing multiple layers in an embodiment of the present invention.

### DETAILED DESCRIPTION OF THE PRESENTLY PREFERRED EMBODIMENTS

The present invention relates to a bag apparatus and/or multilayer absorbent tarp for moving heavy items, specifically heavy items that may leak oils and other like material. Methods of using the same are further provided.

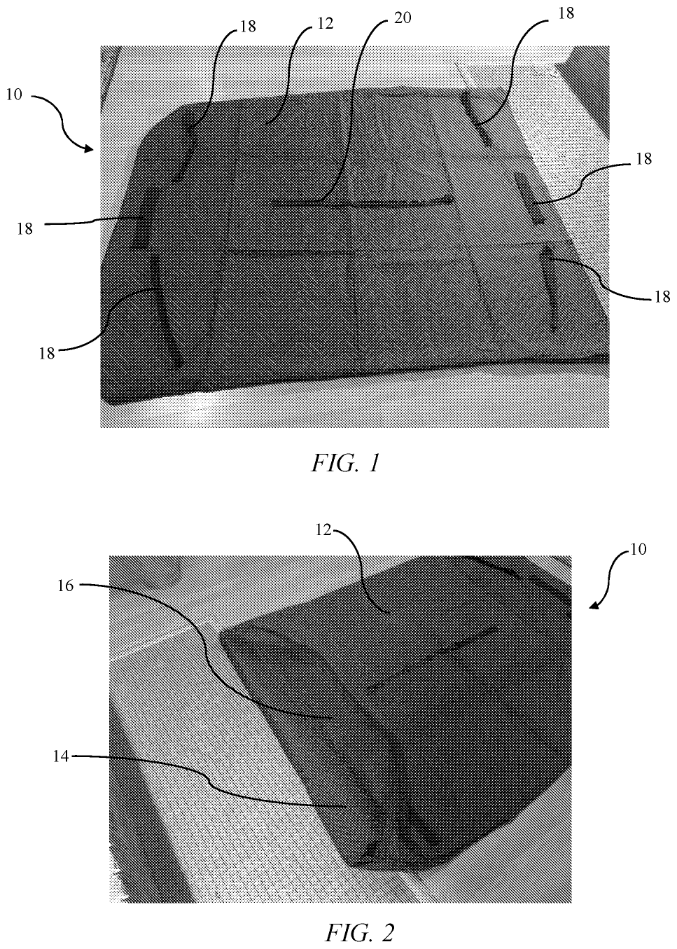

Now referring to the figures, FIG. 1 illustrates a perspective view of a moving bag 10 comprising a top layer 12, and a bottom layer 14, as illustrated in FIG. 2, wherein the top layer 12 and the bottom layer 14 are attached together to form an interior space 16. Specifically, the top layer 12 and bottom layer 14 are adhered or otherwise connected together around a periphery thereof. Preferably, the top layer is sewn to the bottom layer around the periphery thereof. Preferably, the top layer and the bottom layer are attached together completely around periphery, although it should be noted that in embodiments the top layer and the bottom layer may be partially connected together therearound, and may leave an open edge as illustrated in FIG. 2, providing additional functionality for the moving bag 10.

The top layer 12 and/or the bottom layer 14 may be made from a soft absorbent material, specifically to be easily slid on hard surfaces, such as hard flooring, without causing damage thereto. Moreover, the top layer 12 and/or the bottom layer 14 may have an absorbent inner surface to absorb spills of fluids. Also, the top layer and/or the bottom layer 14 may have a blocking layer, such as a fluid blocking layer to prevent fluids or other like materials from passing through the top layer 12 and/or the bottom layer 14 to contain the same. The fluid blocking layer may be on an underside of the bottom layer and/or on a topside of the top layer so that the absorbent inner surface of the bottom layer and/or the top layer each face inwardly to the interior space 16.

The top layer 12 may have a plurality of straps 18 disposed in various locations on a top surface thereof to allow a user to grasp the same and pull upwardly or otherwise hold the moving bag 10. Alternatively, the plurality of straps 18 may be used as tie-down anchor points for holding straps or the like for tying around items moved thereby. In addition, grommets, loops, hooks, or other like elements may protrude from the top surface of the top layer 12 allowing tie-downs to attach thereto.

The top layer 12 may further have a zipper 20 running longitudinally thereacross, thereby allowing the moving bag 10 to open and provide access to the interior space 16. Specifically, in a preferred embodiment, the zipper 20 may be opened and an object may be placed within the interior space 16. If the object is completely placed within the moving bag 10, the zipper may be closed around the object. However, a heavy and relatively large object may be placed within the interior space 16 and protrude through the opening formed by the open zipper. Straps or other tie-downs may be attached to the straps 18, or other elements protruding therefrom, to pull the top layer 12 around the large object, wherein the straps 18 may further allow the object to be moved by manually grasping the same. Because the bottom layer 14 may be made from a soft material, the object may be dragged across flooring without causing damage thereto. In other words, the bottom layer 14 may have a relatively low coefficient of friction against a floor, such as a wood or tile floor or even carpeting, that may allow a user to manually drag the moving bag relatively easily across the floor.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

I claim:

1. A moving bag apparatus comprising:
a top layer of absorbent fabric material and a bottom layer of absorbent fabric material, wherein the top layer and the bottom layer are attached together around a periphery of each of the top layer and the bottom layer,
wherein the top layer comprises a zipper for accessing an interior space between the top layer and the bottom layer, and
wherein the top layer comprises at least one webbing strap extending therefrom.

2. The moving bag apparatus of claim 1 further comprising:
an opening between the top layer and the bottom layer at a peripheral location thereof

3. The moving bag apparatus of claim 1 further comprising:
a fluid blocking layer in the bottom layer.

4. The moving bag apparatus of claim 3 wherein the fluid blocking layer is disposed beneath the absorbent fabric material so that the absorbent fabric material of the bottom layer is positioned adjacent to the interior space.

5. The moving bag apparatus of claim 1 further comprising:
a fluid blocking layer in the top layer.

6. The moving bag apparatus of claim 5 wherein the fluid blocking layer is disposed above the absorbent fabric material so that the absorbent fabric material of the top layer is positioned adjacent to the interior space.

7. The moving bag apparatus of claim 1 wherein the bottom layer has a coefficient of friction configured to allow a user to manually drag the moving bag apparatus across a floor.

8. The moving bag apparatus of claim 1 wherein the zipper runs longitudinally across the top layer.

9. The moving bag apparatus of claim 1 comprising a plurality of webbing straps attached to the top layer.

10. The moving bag apparatus of claim 1 comprising at least one tie-down anchor point on the top layer.

11. A method of using a moving bag apparatus comprising the steps of:
providing a moving bag apparatus comprising a top layer of absorbent fabric material and a bottom layer of absorbent fabric material, wherein the top layer and the bottom layer are attached together around a periphery of each of the top layer and the bottom layer, wherein the top layer comprises a zipper for accessing an interior space between the top layer and the bottom layer, and wherein the top layer comprises at least one webbing strap extending therefrom;
opening the zipper in the top layer; and
placing an item within the interior space.

12. The method of claim 11 further comprising the step of:
closing the zipper around the item within the interior space.

13. The method of claim 11 further comprising the step of:
attaching the webbing strap around the item within the interior space.

14. The method of claim 11 further comprising the steps of:
providing an opening between the top layer and the bottom layer at a peripheral location thereof; and
accessing the item within the interior space via the opening between the top layer and the bottom layer.

15. The method of claim 11 further comprising the step of:
providing a fluid blocking layer in the bottom layer, the top layer, or both the bottom layer and the top layer.

16. The method of claim 15 wherein the fluid blocking layer is disposed adjacent the absorbent fabric material in the top layer or the bottom layer or both the top layer and the bottom layer so that the absorbent fabric material of the bottom layer, the top layer, or both the bottom layer and the top layer is positioned adjacent to the interior space.

17. The method of claim 11 wherein the bottom layer has a coefficient of friction configured to allow a user to manually drag the moving bag apparatus across a floor, and comprising the step of:
dragging the moving bag apparatus having the item therein across a floor.

18. The method of claim 11 wherein the zipper runs longitudinally across the top layer.

19. The method of claim 11 further comprising the step of:
providing a plurality of webbing straps attached to the top layer.

20. The method of claim 11 further comprising the step of:
providing at least one tie-down anchor point on the top layer.
